(19) United States
(12) Patent Application Publication
(10) Pub. No.: US 2010/0055529 A1
(43) Pub. Date: Mar. 4, 2010

(54) WETTABILITY INK, PROCESS AND CARBON COMPOSITE ARTICLES MADE THEREWITH

(76) Inventor: Bryan F. Dufner, West Hartford, CT (US)

Correspondence Address: M P WILLIAMS, 210 MAIN STREET, MANCHESER, CT, 06042, US

(21) Appl. No.: 12/449,751

(22) PCT Filed: Mar. 21, 2007
(86) PCT No.: PCT/US07/07045

§ 371 Date: Aug. 19, 2009

(51) Int. Cl. C09D 11/00; B05D 3/02; H01M 8/10

(52) U.S. Cl. 429/30; 427/115; 106/31.13

(57) ABSTRACT

The wettability of a porous carbon composite article used in a fuel cell is enhanced by a process of impregnating the composite article with a suspension of a wettability enhancing material that contains a thermally activated gelling material such as a methylcellulose gel which is activated at a temperature substantially below the boiling point of water.

### TECHNICAL FIELD

This improvement relates to provision of an ink used to render carbon substrates wettable in a uniform manner, including a thermally activated gelling material such as methylcellulose ether, in a process that deposits wetting agents such as colloidal amorphous carbon particles or porous graphite or carbon or metal oxides or metal oxyhydroxides, and wettable carbon composite articles made thereby.

### BACKGROUND ART

The use of porous carbon-carbon composites and carbon-polymer composites in proton exchange membrane fuel cells (PEMFC) direct methanol fuel cells (DMFC) and phosphoric acid fuel cells (PAFC) is well known. These porous composite articles are used as electrode substrates, sometimes referred to as gas diffusion layers in PEMFCs, DMFCs and PAFCs, electrolyte reservoir plates in PAFCs, and as water transport plates in PEMFCs. These composites tend to be somewhat hydrophobic as fabricated and not completely wetted by the acid used in the PAFC or the water used in the PEMFCs. These materials also tend to become hydrophobic when used on the anode side of PEMFCs and PAFCs due to reduction of carbon oxides in the fuel environment.

U.S. Pat. Nos. 4,185,145 and 4,219,611 to Breault teach the use of colloidal amorphous carbon particles as a means of making the surface of these composites hydrophilic. A carbon powder, such as Vulcan XC-72, is dispersed in a solution of water and a surfactant, such as Triton X-100, by the use of ultra-sonic energy. The substrate is impregnated with this suspension and then dried to remove the water and further heated to volatilize or decompose the surfactant. This method has been used to treat substrates and electrolyte reservoir plates used in PAFCs.

U.S. Pat. No. 4,826,741 to Aldhart teaches rendering a porous, graphite or carbon, fluid permeable member for a PEMFC hydrophilic by impregnation with colloidal silica.

U.S. Pat. No. 5,840,414 to Bett et al and U.S. Pat. No. 6,258,476 to Cipollini teach the use of metal oxides and metal oxyhydroxides as a means of making hydrophilic gas diffusion layers and porous hydrophilic reactant gas flow field plates, also known as water transport plates, used in PEMFCs. A porous gas diffusion layer or water transport plate is vacuum impregnated with a solution of tin tetrachloride pentahydrate in water. The impregnated article is then immersed in a basic solution wherein the tin tetrachloride pentahydrate is converted to an insoluble tin hydroxide. Lastly, the plate is dried to remove the water and calcined at 400° C. to convert the tin hydroxide to a tin oxide. The deposited tin oxide enhances the article wettability so it can be used as a hydrophilic component in a fuel cell.

These methods have a common problem. The wettability enhancing material is not uniformly dispersed across the thickness (through-plane) of the porous part. The concentration of wettability enhancing material is lowest in the center and highest at the surfaces of the porous component. This is because the colloidal carbon or silica migrates toward the surfaces during the drying operation, and the tin oxide diffuses toward the surfaces during the drying step.

The uncontrolled migration of the wettability enhancing material towards the substrate surface results in poor product quality control and design issues such as non-repeatable contact angles that negatively impact performance. This non-uniformity in material deposition can also affect the performance of a PAFC by reducing the in-plane permeability of the acid or by affecting the reactant diffusion losses in a cell by influencing the contact angle and acid distribution between porous components. This non-uniformity of material deposition can affect the performance of a PEMFC by reducing the thru-plane permeability or bubble pressure of a water transport plate and thru-plane permeability and contact angles of the substrates.

A method to improve the uniformity of the deposition of the wettability enhancing material across the thickness of a porous carbon-carbon or porous carbon-polymer composite used in PAFCs, PEMFCs and DMFCs is required.

### SUMMARY

The key to improvements herein is inclusion of a process aid into an impregnate suspension (wettability ink) that restricts mobility of the solids during the oven drying step. The restricted mobility is the result of two differing factors: first, the process aid increases the ink viscosity during oven drying which results in decreased mobility of ink solids, and second, the process aid promotes the forming of a film that binds the ink solids to the fibers of the composite during the oven drying step.

The process aid component is a thermally activated gelling material incorporated into the impregnate suspension used to impregnate the porous composite article with a wettability agent. The thermally activated material experiences a significant increase in viscosity as the porous composite article containing the impregnate suspension is heated. This increase in viscosity reduces the migration of the colloidal carbon or silica to the surface of the porous composite during the drying step and results in a product with improved uniformity and increased in-plane permeability.

The improvement utilizes, for example, various methylcellulose products, such as those sold under the tradename, METHOCEL, by Dow Chemical. An exemplary process of the invention is to prepare an ink comprising, by weight, 1% carbon black, 0.5% surfactant, 2% methylcellulose, and the remainder water. The carbon is dispersed by ultrasonic mixing to form a suspension or ink. The porous composites are saturated by immersing them in the ink. The impregnated composites are then heated, which increases the viscosity and prevents the migration of the carbon, evaporates the water and surfactant, and decomposes the methylcellulose. The resulting loading of the carbon black is on the order of about 5 to about 6 milligrams per milliliter of composite.

### MODE(S) OF IMPLEMENTATION

In one comparable test, two wettability treatment inks were made, each comprising 1% by weight of Vulcan XC-72 carbon black manufactured by Cabot, 0.5% by weight Triton X-100 surfactant manufactured by Dow, and the remainder water. However, one of the inks also included 2% by weight METHOCEL A15, a thermally activated methylcellulose gelling agent manufactured by Dow. The carbon in both inks was dispersed by ultra-sonic mixing into a stable suspension or ink. PAFC substrates 0.3 to 0.4 mm in thickness were then saturated by immersing them in the inks. The impregnated substrates were then placed into a forced convection oven at between 650° F. and 700° F. (340° C. and 370° C.) which evaporated the water and surfactant and decomposed the METHOCEL. The loading of carbon black in both substrates was about 6 milligrams per milliliter of substrate.

The in-plane permeability of the substrates were measured using water at room temperature. The substrate without METHOCEL exhibited a permeability of 5(10)⁻¹⁵ square meters, whereas the substrate formed using the wettability treatment ink of this improvement exhibited permeability of 6(10)⁻¹³ square meters. In other instances, identical substrates processed without the present improvement exhibited in-plane permeability of between 3(10)⁻¹⁵ square meters and 5(10)⁻¹⁵ square meters, whereas substrates treated with the wettability treatment ink of this improvement exhibited water permeability ranging between 8(10)⁻¹⁴ square meters and 6(10)⁻¹³ square meters.

These figures were consistent in tests involving substrates with and without the improvement of the present invention having between about 5 mg/cc and about 13 mg/cc ink solids content.

Scanning electron micrographs were obtained of cross-sections of substrates treated by the wettability treatment ink of the prior art not including methylcellulose, and otherwise identical substrates treated with wettability treatment inks including methylcellulose, according to the improvement herein. The micrographs revealed that the substrates treated with the prior art wettability ink clearly had high concentrations of the wettability treatment ink near the surfaces of the substrates, with much lower concentrations of treatment wettability ink in the center of the substrates. On the other hand, the micrographs revealed an almost uniform scattering of the wettability treatment ink throughout the cross section of the substrates treated in accordance with the improvement herein, using a wettability treatment ink including methylcellulose.

The improvement herein provides uniform wettability throughout the cross section of the substrate. This improved uniformity means that suitable wettability can be achieved with less wettability ink being used in the process. Reduced substrate ink solids loading means increased substrate porosity and improved permeability. The improved wettability consistency results in more uniform contact angles among the anode and cathode articles over the operating life of the electrochemical cells using these components, which in turn results in a more uniform distribution of electrolyte or coolant water, as the case may be, between the anode and the cathode.

1. (canceled)

2. Enhancing the wettability of a porous composite article configured for use in a fuel cell by impregnating the composite article with an aqueous suspension including a wettability enhancing material and a thermally activated gelling material, thermally activating the gelling material at a temperature substantially below the boiling point of water, and heating the article to remove water.

3. A process according to claim 2 wherein said gelling material is a methylcellulose gel.

4. (canceled)

5. A porous composite article made according to the process of claim 2.

6. A porous composite article made according to the process of claim 3.

7. A wettability ink comprising by weight, from about 0.5% to about 2% of carbon black, from about 0.2% to about 0.8% of surfactant, and from about 1.5% to about 2.5% of a thermally activated gelling material, balance water.

8. A wettability ink according to claim 7 wherein said gelling material is a methylcellulose gel.

9. A process for enhancing the wettability of a porous composite article configured for use in a fuel cell which comprises impregnating the composite article with the wettability ink according to claim 7; and
heating the impregnated composite article sufficiently to remove water and surfactant.

10. A process for enhancing the wettability of a porous composite article configured for use in a fuel cell which comprises impregnating the composite article with the wettability ink according to claim 8; and
heating the impregnated composite article sufficiently to remove water and surfactant.

11. A porous composite article made according to the process of claim 9.

12. A porous composite article made according to the process of claim 10.

13. A process comprising:
substantially saturating a porous composite article with a suspension that includes a wettability enhancing material and process aids; and
heating the suspension-saturated article to a temperature sufficient to remove water and process aids of the suspension from the article;
characterized by:
reducing mobility of the wettability enhancing material during the heating step to resist migration of the wettability enhancing material toward the surface of the article by including a thermally activated gelling material in the suspension which increases the viscosity of the suspension at a temperature lower than the boiling point of water.

14. A porous composite article made according to the process of claim 13.
